(19) United States
(12) Patent Application Publication
(10) Pub. No.: US 2011/0214753 A1
(43) Pub. Date: Sep. 8, 2011

(54) MAGNETIC DEVICE AND METHOD OF USING SUCH DEVICE TO CLEAN THE INNER SURFACE OF A TUBE, AND METHODS AND DEVICES FOR SIPHONING FLUID

(76) Inventor: Julian Sprung, Miami Beach, FL (US)

(21) Appl. No.: 13/042,109

(22) Filed: Mar. 7, 2011

Related U.S. Application Data
(60) Provisional application No. 61/310,908, filed on Mar. 5, 2010.

(51) Int. Cl. F16L 43/00; B08B 1/00; B08B 9/04

(52) U.S. Cl. 137/142; 15/104.16; 137/15.07

(57) ABSTRACT

A tube cleaning device is provided including a first member and a second member. The first member includes a first magnetic or magnetically attractable element and an abrasive cleaning surface. The second member includes a second magnetic or magnetically attractable element magnetically attracted to or by the first magnetic or magnetically attractable element. When the first member is inserted within a tube and the second member is positioned adjacent an outer wall of the tube, the abrasive surface of the first member contacts an inner wall of the tube. By moving the second member along and/or around the outer wall of the tube, the abrasive surface cleans the inner wall of the tube.

### CROSS-REFERENCE TO RELATED APPLICATIONS

This application claims the priority benefit of U.S. Provisional Application No. 61/310,908, filed Mar. 5, 2010, and entitled “MAGNETIC TUBE CLEANING DEVICE AND METHOD OF USING SUCH DEVICE TO CLEAN THE INNER SURFACE OF A TUBE, AND METHODS AND DEVICES FOR SIPHONING FLUID,” the entirety of which is hereby incorporated by reference to the extent permitted by law.

### BACKGROUND

1. Field of Invention

The invention is related to a cleaning device and method for removing material from the inner surface of a tube, pipe, or hose to be cleaned. More particularly, the invention is related to a magnetic cleaning device having an outer member and an inner member, the outer member being magnetically attracted to the inner member. The inner member may include an abrasive cleaning surface. The invention is related to methods and devices for siphoning fluid.

2. Related Art

In various applications utilizing pipes, tubes, and hoses to transport material, the deposit of various materials on the inner walls may require regular or periodic cleaning. This is the case, for example, in aquarium plumbing, home plumbing, industrial plumbing, and any situation where a liquid or other material is flowing through a tube over long periods of time.

Known devices for cleaning pipes may include “pigs” which are typically moved through the pipe to be cleaned by water pressure or gravity (known as “pigging”). A heavy pig, however, can get stuck within the pipe when, for example, a big or hard deposit exists and may be difficult to remove. Another known device, the foxtail brush, is formed from lengths of braided metal with a brush at one end for insertion into an open end of a pipe, tube, or hose and is manually manipulated to remove deposits coating the inner wall. The reach of a foxtail brush is limited by its length, so it may not be capable of removing deposits in a long length of hose.

### SUMMARY

In an embodiment of the invention, a tube cleaning device may include magnetically attracted first and second members. The first member may include a first magnetic or magnetically attractable element and an abrasive cleaning surface. The second member may include a second magnetic or magnetically attractable element magnetically attracted to or by the first magnetic or magnetically attractable element. When the first member is inserted within a tube and the second member is positioned adjacent an outer wall of the tube, the abrasive surface of the first member contacts an inner wall of the tube to allow for cleaning thereof.

In accordance with another example embodiment, a method for cleaning the inner surface of a tube may be provided. The method may include inserting a first member within a tube. The first member may include a first magnetic or magnetically attractable element and an abrasive cleaning surface. The method may include placing a second member adjacent to or on an outer surface of the tube. The second member may include a second magnetic or magnetically attractable element magnetically attracted to or by the first magnetic or magnetically attractable element such that the abrasive surface of the first member contacts an inner wall of the tube. The method may include moving the second member along and/or around the outer wall of the tube to clean the inner wall of the tube with the abrasive surface.

In accordance with another example embodiment, a method for starting or creating a siphon within a tube may be provided. The method may include providing a length of tube having first and second open ends and inserting a first member including a first magnetic or magnetically attractable element into the tube. A dimension of the first member may be approximately equal to an inner diameter of the tube. The method may include placing the first open end of the tube into a fluid and placing a second member adjacent to or on an outer surface of the tube proximate the first member. The second member may include a second magnetic or magnetically attractable element magnetically attracted to or by the first magnetic or magnetically attractable element. The method may include moving the second member along the outer wall of the tube from the first open end toward the second open end to generate a siphon within the tube.

In accordance with another example embodiment, a device for creating a siphon within a tube is provided. The device may include a housing including an inner lumen extending between first and second open ends. At least one of the first and second open ends of the housing may be configured to be coupled to the tube. The device may include a first member including a magnetic or magnetically attractable element. The first member may have a dimension approximately equal to a diameter of the inner lumen and may be configured to be moveably received in the inner lumen of the housing. A second member may include a magnetic or magnetically attractable element attracted to or by the first magnetic or magnetically attractable element.

In accordance with another example embodiment, a method for siphoning fluid may be provided. The method may include providing a length of tube having first and second open ends, placing the first open end of the tube into a fluid, and coupling a siphon creating device to the second open end of the tube. The siphon creating device may include a housing having an inner lumen extending between first and second open ends, a first member moveably received in the inner lumen of the housing, and a second member including a magnetic or magnetically attractable element attracted to or by the first magnetic or magnetically attractable element. The first member may include a magnetic or magnetically attractable element and may have a dimension approximately equal to a diameter of the inner lumen. The method may include moving the second member along an outer wall of the housing in a direction away from the first open end of the tube.

Further features and advantages of the invention, as well as the structure and operation of various embodiments of the invention, are described in detail below with reference to the accompanying drawings.

### BRIEF DESCRIPTION OF THE DRAWING FIGURES

The foregoing and other features and advantages of the invention will be apparent from the following, more particular description of some example embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 depicts a schematic side cross-sectional view of a magnetic cleaning device and method utilizing such device according to an embodiment of the invention;

FIG. 2 depicts a schematic side view of an inner member of the magnetic cleaning device of FIG. 1 according to another embodiment of the invention;

FIG. 3. depicts a schematic side view of the inner member of the magnetic cleaning device of FIG. 1 according to another embodiment of the invention;

FIG. 4. depicts a schematic side view of the inner member of the magnetic cleaning device of FIG. 1 according to another embodiment of the invention;

FIG. 5. depicts several general shapes of a magnetic or magnetically attractable element for an inner member of the magnetic cleaning device according to embodiments of the invention;

FIG. 6 depicts a method and device for generating a siphon within a tube utilizing several magnetically attracted elements according to an embodiment of the invention;

FIG. 7 depicts a device and method for siphoning fluid according to another embodiment of the invention; and

FIG. 8 depicts a device and method for siphoning fluid according to another embodiment of the invention.

### DETAILED DESCRIPTION

Various embodiments of the invention are discussed in detail below. While specific embodiments are discussed, specific terminology is employed for the sake of clarity. However, the invention is not intended to be limited to the specific terminology so selected and it should be understood that this is done for illustration purposes only. A person skilled in the relevant art will recognize that other components and configurations can be used without parting from the spirit and scope of the invention. Each specific element includes all technical equivalents that operate in a similar manner to accomplish a similar purpose.

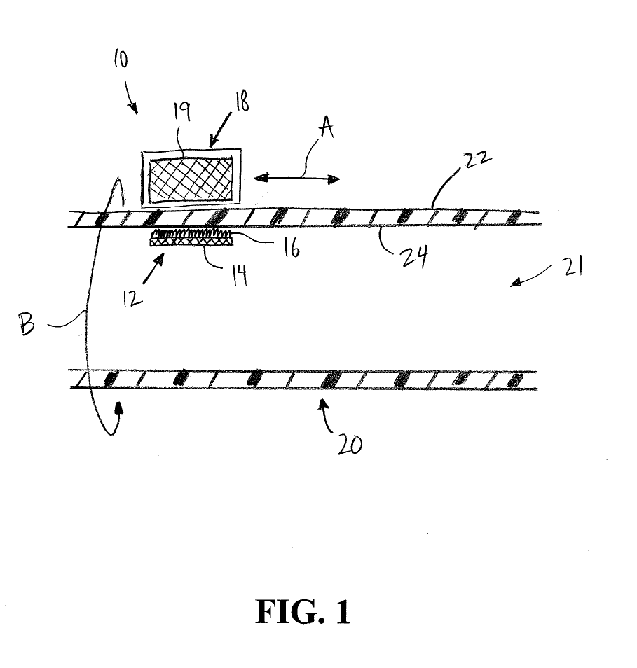

FIG. 1 depicts a magnetic tube cleaning device 10 and method utilizing such device 10 according to an embodiment of the invention. The tube cleaning device 10 may include a first member 12 including a first magnetic or magnetically attractable element 14 and an abrasive cleaning surface 16. A second member 18 may include a second magnetic or magnetically attractable element 19 which is magnetically attracted to or by the first magnetic or magnetically attractable element 14 of the first member 12. The first member 12 may be configured to be inserted within the lumen 21 of a tube 20 such as, for example but not limited to, a tube utilized in aquarium plumbing. The second member 18 may be positioned adjacent an outer wall 22 of the tube 20 such that the abrasive surface 16 of the first member 12 contacts an inner wall 24 of the tube 20. The first member 12 may be flexible such that, the abrasive cleaning surface 16 bends or conforms to the inner surface 24 of the tube circumferentially and, in cases where the tube 20 is defined by soft tubing material, also bends or conforms to the inner surface 24 of the tube along an axial direction thereof (e.g., along bends in the tube). The first and second magnetic or magnetically attractable members 14, 19 may be, for example but not limited to, one or more neodymium magnets, another type of magnet, or some magnetically attractable metallic material so long as each is magnetically attracted to the other. The abrasive cleaning surface 16 may be, for example but not limited to, an adhesive-backed strip of a hook or loop portion of hook-and-loop fastener, a strip of plastic or polymer material having molded ridges or protrusions, a plurality of metallic blades, or a combination.

Utilizing the cleaning device 10, a user may clean mineral, bacterial, algal, or invertebrate growths and deposits from the inner wall or surface 24 of the tube 20 by inserting the first member 12 within the tube lumen 21, placing the second member 18 adjacent to or on the outer wall or surface 22 of the tube 20 so as to bring the abrasive surface 16 of the first member 12 into contact with the inner wall 24, and then moving the second member 18 along (e.g., back and forth—see arrow A) and/or around (see arrow B) the outer wall 22 of the tube 20. The second magnetic or magnetically attractable member 19 of the second member 18 may be disposed within an ergonomically designed casing so that a user may comfortably hold and move it along the length of the pipe or hose. The casing may be, for example but not limited to, molded plastic or die-cut pieces of EVA foam or a combination of these.

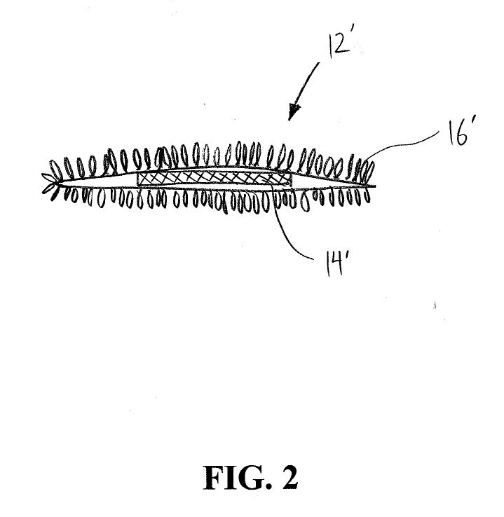

FIG. 2 depicts a schematic side view of the first (inner) member 12′ according to another embodiment of the invention. The first magnetic or magnetically attractable member 14′ may be, for example, disk-shaped or plate-like and may be surrounded by or contained within the abrasive cleaning surface 16′ which may be, for example but not limited to, a folded strip of adhesive-backed hook or loop portion of hook-and-loop fastener. In addition to disk-shaped and plate-like magnets, member 14′ could be made, for example, from cylindrical magnet(s) or a series of small magnets or magnetically attractable material. The orientation (i.e., polarity) of the magnets to be coupled must be complimentary to achieve ideal cleaning force and ease of propulsion through the tube.

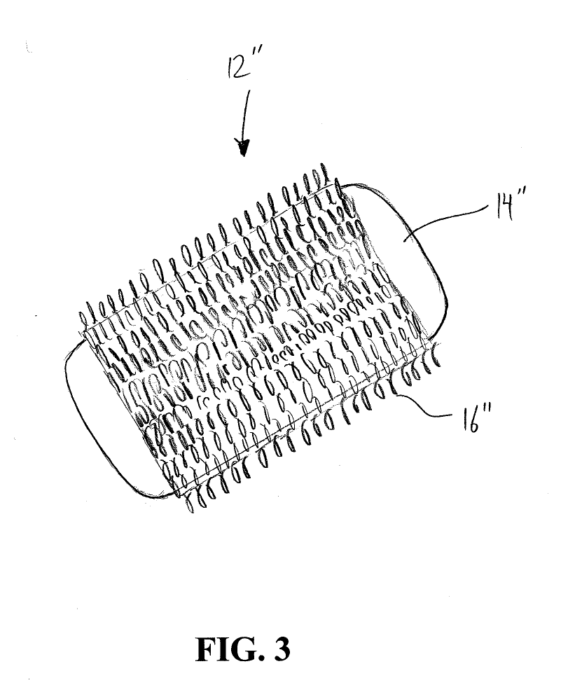

FIG. 3 depicts a schematic side view of the inner member 12″ according to another embodiment of the invention. The first magnetic or magnetically attractable member 14″ may be, for example but not limited to, one or more magnetic or magnetically attractable elements in a cylindrical or conical form and may be surrounded by or contained within the abrasive cleaning surface 16″ which may be, for example but not limited to, a wrapped strip of adhesive-backed hook or loop portion of hook-and-loop fastener.

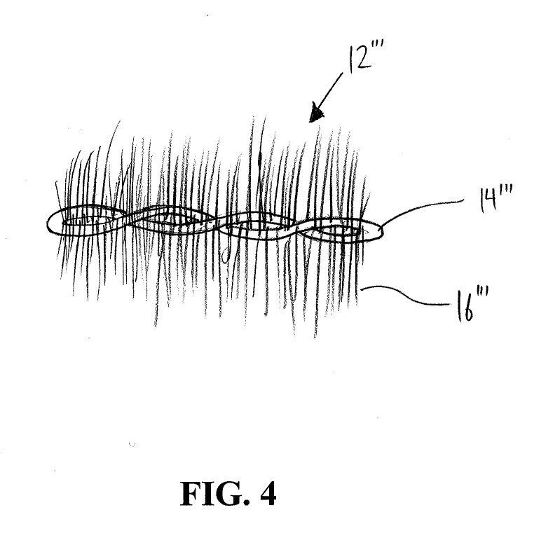

FIG. 4. depicts a schematic side view of the inner member 12′″ according to another embodiment of the invention. The first magnetic or magnetically attractable member 14′″ may be, for example but noted limited to, a braided or twisted metallic or magnetized wire and the abrasive cleaning surface 16′″ may be, for example but not limited to, a plurality of coarse bristles secured thereto. The braided member 14′″ could be, for example but not limited to, stainless steel or steel coated with a protective material to prevent corrosion.

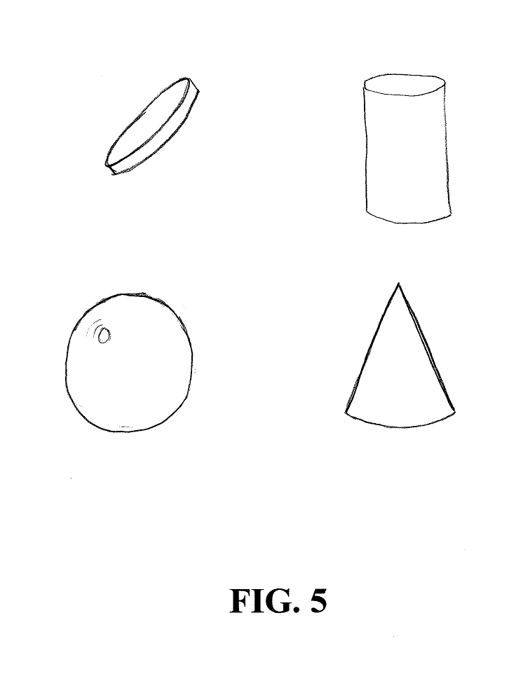

FIG. 5. depicts several general shapes of the first magnetic or magnetically attractable element 14 according to embodiments of the invention. The element 14 may be, for example but not limited to, a disk, cylinder, a braided member, a sphere, a cone or a combination. The element 14 may include a series of blocks or cylinders flexibly attached. The length of the inner element 14 may be, for example but not limited to, approximately between 1 inch and 3 inches for use in aquarium plumbing applications. An alternative design (not shown) for the first (inner) member for use in soft hose cleaning could be, for example, as a volume of small granular pieces of hematite or any other form of magnetically attractable iron with sharp angular edges. The edges of the granules would scrub the inside surfaces of the tube, pipe or hose as the second (outer) element is moved along/around the outside of the tube by the user.

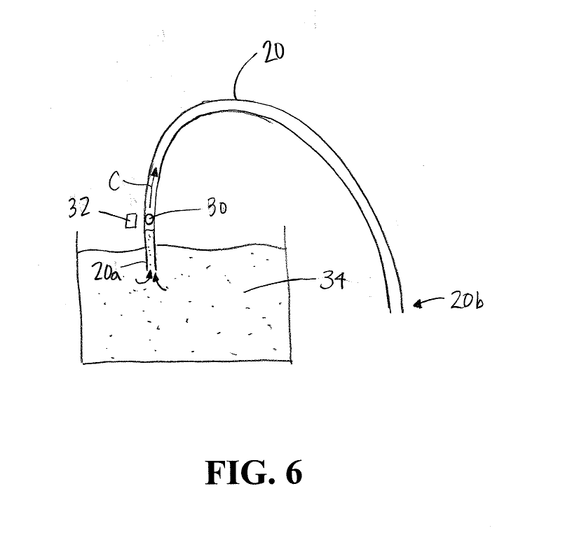

FIG. 6 depicts a method and mechanism for generating a siphon within a tube 20 utilizing several magnetically attracted elements 30, 32 according to an embodiment of the invention. The tube 20 may have first and second open ends 20a, 20b. The first magnetic or magnetically attractable element 30 may be inserted into one of the first or second open ends 20a, 20b of the tube 20. A dimension of the first element 30 may be approximately equal to an inner diameter of the tube 20. The first element 32 may be, for example but not limited to, a sphere. A user may then place the first open end 20a of the tube 20 into a fluid 34 to be siphoned. The user may then place the second element 32 adjacent to or on an outer surface of the tube 20 proximate the position of the first element 30. The first and second magnetic or magnetically attractable elements 30, 32 may be attracted to or by one another. In the case where the user inserts the first element into the second open end 20b, the user must initially move the second element 32 along the outer wall of the tube 20 toward the first open end 20a. Once the first element 30 is positioned proximate to the first open end 20a, the user may then move the second element 32 along the outer wall of the tube 20 toward the second open end 20b in direction C. By doing so, air in the tube 20 is pushed out the second open end 20b and the fluid 34 is drawn in first open end 20a creating a siphoning action. The first element 30 can be drawn out the second open end 20b whereupon it is attracted to the second element 32, while the fluid 34 flowing up the tube 20 and out of the second open end 20b may be directed into a receptacle (not shown).

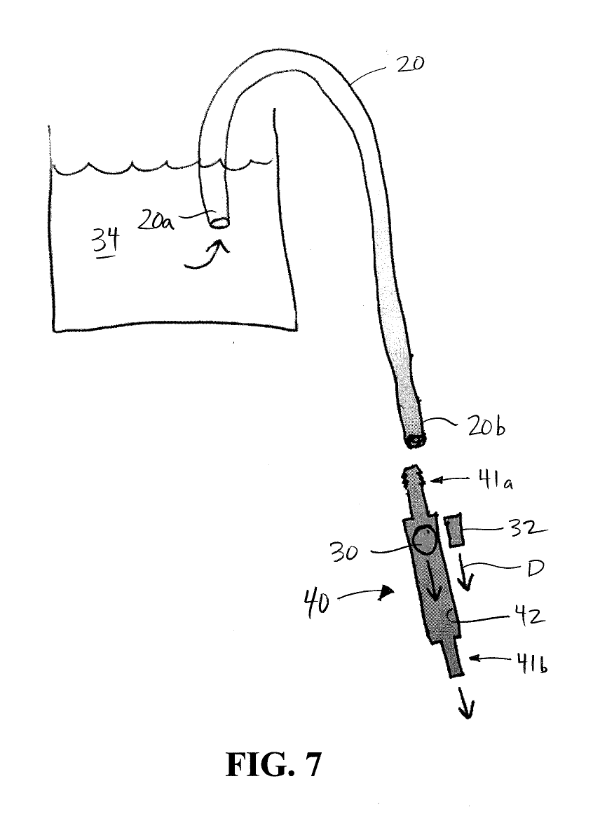

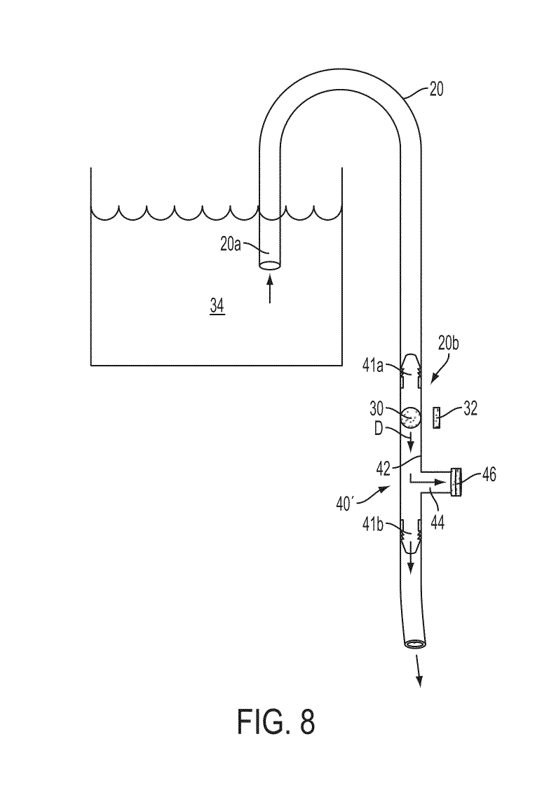

FIG. 7 depicts a device and method for siphoning fluid through a tube 20 (see FIG. 6) according to another embodiment of the invention. The device may include a housing 40 as well as first and second members 30, 32, each of which includes a magnetic or magnetically attractable element attracted to or by the other. The housing 40 includes an inner lumen 42 extending between first and second open ends 41a, 41b. At least one of the first and second open ends 41a, 41b may be configured to be coupled to the tube 20 such as, for example, by including a male coupling (e.g., externally threaded or barbed) sized and configured for receipt in an open end 20b of the tube 20 or a female coupling (e.g., internally threaded or barbed) sized and configured to receive the open end 20b of the tube 20. A friction fit or snap fit may also be sufficient. The first member 30 may have a dimension approximately equal to a diameter of the inner lumen 42 of the housing 40 and may be configured to be moveably received in the inner lumen 42 of the housing 40. As shown in another embodiment depicted in FIG. 8, the housing 40′ may be a T-fitting defined by a second inner lumen 44 substantially normal to the inner lumen 42. The second inner lumen 44 may extend between the inner lumen 42 and a closed end 46 and may be sized and configured to receive the first member 30.

The device shown in FIGS. 7 and 8 may be utilized in a method for siphoning fluid 34. The device may be coupled to the second open end 20b of the tube 20, the first open end 20a of the tube 20 being disposed in the fluid 34. A user may then position the second member 32 along an outer wall of the housing 40 (or 40′) such that it is magnetically coupled with the first member 30, and then move the second member 32 in a direction D. In the embodiment depicted in FIG. 7, the device may need to be removed from the second open end 20b of the tube 20 once the siphon is started in order to allow the fluid 34 flowing up the tube 20 and out of the second open end 20b to be directed into a receptacle (not shown). In the embodiment depicted in FIG. 8, however, the first member 30 may be drawn into the second inner lumen 42 by the second member 32 during/after the siphoning action is generated obviating any need for removal of the device from the second open end 20b of the tube 20 and still allowing the fluid 34 flowing up the tube 20 and out of the second open end 20b to be directed into a receptacle (not shown).

While various embodiments of the present invention have been described above, it should be understood that they have been presented by way of example only, and not limitation. Thus, the breadth and scope of the invention should not be limited by the above-described embodiment, but should instead be defined only in accordance with the following claims and their equivalents.

1. A tube cleaning device comprising:
a first member including a first magnetic or magnetically attractable element and an abrasive cleaning surface;
a second member including a second magnetic or magnetically attractable element and being magnetically attracted to or by the first magnetic or magnetically attractable element, whereby when the first member is inserted within a tube and the second member is positioned adjacent an outer wall of the tube, the abrasive surface of the first member contacts an inner wall of the tube.

2. The device of claim 1, wherein the abrasive cleaning surface comprises a strip of a hook or loop portion of a hook-and-loop fastener, a strip of plastic or polymer material having molded ridges or protrusions, a plurality of metallic blades, or a combination.

3. The device of claim 2, wherein the hook or loop portion comprises a folded strip or two separate strips containing the first magnetic or magnetically attractable element.

4. The device of claim 2, wherein the hook or loop portion surrounds the first magnetic or magnetically attractable element.

5. The device of claim 1, wherein the first magnetic or magnetically attractable element comprises a disk, a cylinder, a braided member, a sphere, or a cone.

6. The device of claim 1, wherein the abrasive cleaning surface comprises a plurality bristles secured to the first magnetic or magnetically attractable element.

7. The device of claim 1, wherein the first magnetic or magnetically attractable element comprises a braided member and the abrasive cleaning surface comprises a plurality bristles secured thereto.

8. The device of claim 1, wherein the first member is flexible.

9. A method for cleaning the inner surface of a tube, comprising:
inserting a first member within a tube, wherein the first member includes a first magnetic or magnetically attractable element and an abrasive cleaning surface;
placing a second member adjacent to or on an outer surface of the tube, the second member including a second magnetic or magnetically attractable element magnetically attracted to or by the first magnetic or magnetically attractable element such that the abrasive surface of the first member contacts an inner wall of the tube; and
moving the second member along and/or around the outer wall of the tube to clean the inner wall of the tube with the abrasive surface.

10. The method of claim 9, wherein the abrasive cleaning surface comprises a strip of a hook or loop portion of a hook-and-loop fastener, a strip of plastic or polymer material having molded ridges or protrusions, a plurality of metallic blades, or a combination.

11. The method of claim 10, wherein the hook or loop portion comprises a folded strip or two separate strips containing the first magnetic or magnetically attractable element.

12. The method of claim 10, wherein the hook or loop portion surrounds the first magnetic or magnetically attractable element.

13. The method of claim 9, wherein the first magnetic or magnetically attractable element comprises a disk, a cylinder, a braided member, a sphere, or a cone.

14. The method of claim 9, wherein the abrasive cleaning surface comprises a plurality bristles secured to the first magnetic or magnetically attractable element.

15. The method of claim 9, wherein the first magnetic or magnetically attractable element comprises a braided member and the abrasive cleaning surface comprises a plurality bristles secured thereto.

16. The method of claim 9, wherein the first member is flexible.

17. A device for creating a siphon within a tube, comprising:
a housing including an inner lumen extending between first and second open ends, at least one of the first and second open ends configured to be coupled to the tube;
a first member including a magnetic or magnetically attractable element and having a dimension approximately equal to a diameter of the inner lumen, the first member configured to be moveably received in the inner lumen of the housing; and
a second member including a magnetic or magnetically attractable element attracted to or by the first magnetic or magnetically attractable element.

18. The device of claim 17, wherein at least one of the first and second open ends of the housing comprises a male coupling sized and configured for receipt in an open end of the tube.

19. The device of claim 17, wherein at least one of the first and second open ends of the housing comprises a female coupling sized and configured to receive an open end of the tube.

20. The device of claim 17, wherein the housing comprises a T-fitting defined by a second inner lumen substantially normal to the inner lumen, the second inner lumen sized and configured to receive the first member.

21. The device of claim 20, wherein the second inner lumen extends between the inner lumen and a closed end.
